(19) United States
(12) Patent Application Publication
(10) Pub. No.: US 2025/0086774 A1
(43) Pub. Date: Mar. 13, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Hirotake SASAKI, Kanagawa (JP); Kiyoshi IIDA, Kanagawa (JP)

(73) Assignee: FUJIFILM Business Innovation Corp., Tokyo (JP)

(21) Appl. No.: 18/432,042

(22) Filed: Feb. 4, 2024

(30) Foreign Application Priority Data
Sep. 12, 2023 (JP) 2023-147292

(51) Int. Cl. G06T 7/00; G06V 10/74

(52) U.S. Cl. CPC G06T 7/0004; G06V 10/761; G06T 2207/30164

(57) ABSTRACT

An information processing system includes a processor, in which the processor is configured to acquire a captured image of parts detached from an apparatus, use the captured image to select, from among pieces of detachment information stored in a storage unit, the pieces of detachment information each indicating a detachment procedure for parts from the apparatus, one of the pieces of detachment information corresponding to the parts detached from the apparatus, and present attachment procedure information indicating an attachment procedure to the apparatus, the attachment procedure being set by reversing the detachment procedure for the parts, the detachment procedure being indicated by the one of the pieces of detachment information being selected.

### CROSS-REFERENCE TO RELATED APPLICATIONS

This application is based on and claims priority under 35 USC 119 from Japanese Patent Application No. 2023-147292 filed Sep. 12, 2023.

### BACKGROUND

### (i) Technical Field

The present disclosure relates to an information processing system and a non-transitory computer readable medium.

### (ii) Related Art

There have been proposed various techniques for supporting an operation of re-attaching detached parts to an apparatus when performing maintenance on the apparatus, for example.

For example, Japanese Unexamined Patent Application Publication No. 2021-180408 has proposed a technique of capturing a video of an operation of detaching parts from an apparatus, and playing and presenting the captured video in a reverse manner, thereby supporting an operation of re-attaching the parts to the apparatus. Examples of the related art include Japanese Unexamined Patent Application Publication No. 2017-097856 and Japanese Unexamined Patent Application Publication No. 2019-163670.

### SUMMARY

In such a related art, however, it is necessary to cause a video played in a reverse manner to be viewed when the parts are re-attached to the apparatus. For this reason, it may take time for an operator to recognize an order of re-attaching the parts to the apparatus.

Furthermore, in such a related art, when no video has been captured, it is impossible to provide information for re-attaching parts to an apparatus. That is, when it is noticed that it has been failed to capture a video after parts have been detached from an apparatus, there may be a possibility that it is difficult to re-attach the parts to the apparatus.

Aspects of non-limiting embodiments of the present disclosure relate to referring to parts that have been detached from an apparatus to provide information for supporting attachment of the parts to the apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor, in which the processor is configured to acquire a captured image of parts detached from an apparatus, use the captured image to select, from among pieces of detachment information stored in a storage unit, the pieces of detachment information each indicating a detachment procedure for parts from the apparatus, one of the pieces of detachment information corresponding to the parts detached from the apparatus, and present attachment procedure information indicating an attachment procedure to the apparatus, the attachment procedure being set by reversing the detachment procedure for the parts, the detachment procedure being indicated by the one of the pieces of detachment information being selected.

### BRIEF DESCRIPTION OF THE DRAWINGS

An exemplary embodiment of the present disclosure will be described in detail based on the following figures, wherein:

FIG. 1 is an overall configuration diagram of a work support system according to an exemplary embodiment, and is a diagram schematically illustrating a flow of basic processing of presenting an attachment procedure;

FIG. 2 is a block configuration diagram illustrating the work support system according to the exemplary embodiment;

FIG. 3A is a flowchart illustrating part attachment procedure presentation processing according to the exemplary embodiment;

FIG. 3B is a flowchart subsequent to that illustrated in FIG. 3A;

FIGS. 4A to 4D are diagrams schematically illustrating processing of making a correction in a work target list acquired from a captured image, according to the exemplary embodiment;

FIG. 5 is a diagram illustrating an example of screen display of attachment procedure information displayed on a mobile terminal, according to the exemplary embodiment;

FIG. 6 is a diagram illustrating another example of screen display of attachment procedure information displayed on the mobile terminal, according to the exemplary embodiment; and

FIG. 7 is a diagram illustrating still another example of screen display of attachment procedure information displayed on the mobile terminal, according to the exemplary embodiment.

### DETAILED DESCRIPTION

Hereinafter, a preferred exemplary embodiment of the present disclosure will be described with reference to the drawings.

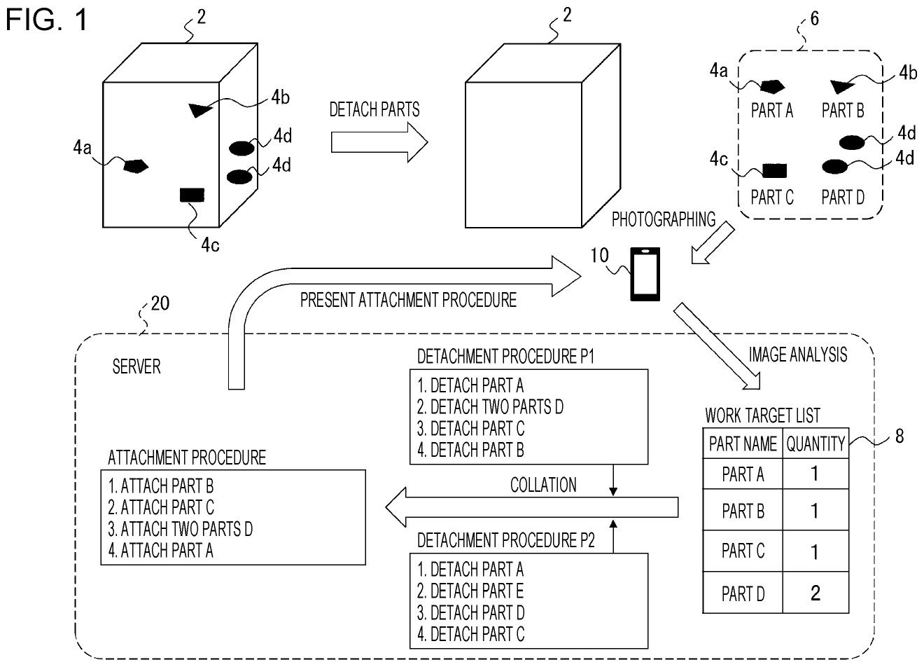

FIG. 1 is an overall configuration diagram of a work support system according to the exemplary embodiment, and is a diagram schematically illustrating a flow of basic processing of presenting an attachment procedure. The work support system according to the exemplary embodiment is utilized for supporting maintenance works and other similar works on an apparatus 2 installed in a facility such as a building. The apparatus 2 is, for example, a multifunction machine. In a maintenance work, such an operation is performed that a plurality of parts 4 assembled to the apparatus 2 are detached, and the parts 4 that have been detached are re-attached. Works to which it is possible to apply the work support system according to the exemplary embodiment is not limited to such maintenance works, as long as works of detaching parts 4 from an apparatus 2 and re-attaching the parts 4 are included.

Note that parts 4a to 4d, when they are not necessarily distinguished from each other, are collectively referred to as “parts 4” as described above.

The work support system according to the exemplary embodiment includes a mobile terminal 10 and a server 20. The mobile terminal 10 is carried by an operator who performs a maintenance work, is brought to a work site, and is utilized. The mobile terminal 10 is assumed to be, for example, a smartphone or a tablet terminal. The mobile terminal 10 may be realized by a conventional general-purpose hardware configuration. That is, the mobile terminal 10 includes a central processing unit (CPU), a read-only memory (ROM), a random access memory (RAM), a storage, a network interface provided as a communication component that performs communications with the server 20, and a touch panel serving as a user interface. Furthermore, the mobile terminal 10 according to the exemplary embodiment is equipped with a camera serving as an imaging component. Even if no imaging component is installed, the mobile terminal 10 needs to have an interface for connection with an imaging component.

Note that just a single mobile terminal 10 is illustrated in FIG. 1, since, although the work support system may include a plurality of such mobile terminals 10, it is sufficient that the individual mobile terminals 10 equivalently have processing functions that will be described later in detail.

When a captured image of the parts 4 detached from the apparatus 2 is transmitted from the mobile terminal 10, the server 20 identifies a work procedure manual for detaching the parts 4 that has been detached, refers to the identified work procedure manual, and creates and presents, to the operator, a procedure for attaching the parts 4 to the apparatus 2. The server 20 may be realized by a conventional general-purpose hardware configuration. That is, the server 20 at least includes a CPU, a ROM, a RAM, a storage, and a network interface provided as a communication component that performs communications with the mobile terminal 10.

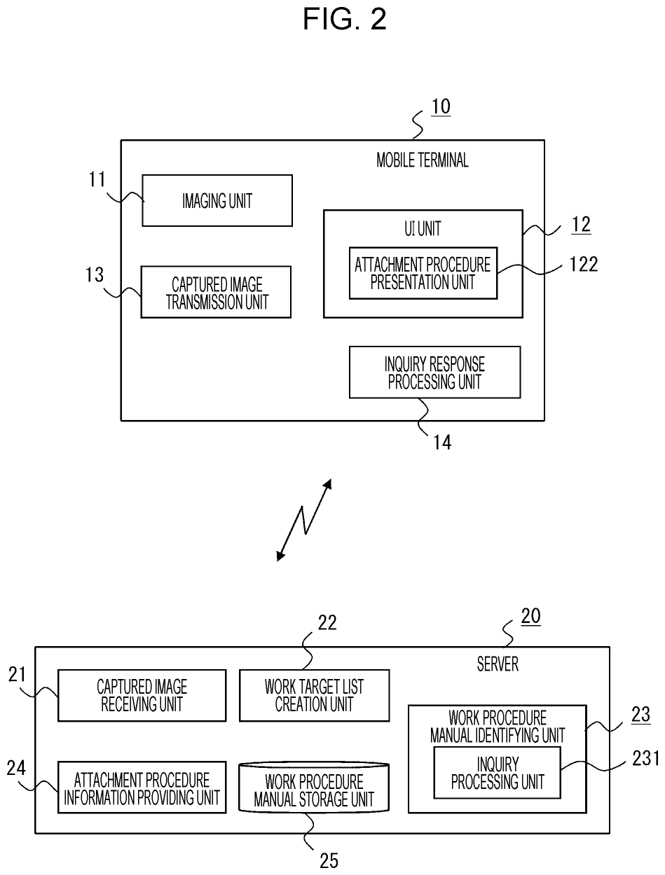

FIG. 2 is a block configuration diagram illustrating the work support system according to the exemplary embodiment. The work support system according to the exemplary embodiment includes the mobile terminal 10 and the server 20, as described above. The mobile terminal 10 includes an imaging unit 11, a user interface (UI) unit 12, a captured image transmission unit 13, and an inquiry response processing unit 14. Note that components that are not used to describe the exemplary embodiment are omitted from the drawing.

The imaging unit 11 is realized by the camera, and captures an image in accordance with an operation performed by the operator. In the case of the exemplary embodiment, the operator uses the camera to capture an image of the parts 4 detached from the apparatus 2. The UI unit 12 is configured to receive a user input from the touch panel, and perform display on the touch panel. An attachment procedure presentation unit 122 in the UI unit 12 is configured to display, on the touch panel, and present, to the operator, attachment procedure information transmitted from the server 20, for example. The captured image transmission unit 13 is configured to transmit the captured image by the imaging unit 11 to the server 20. The inquiry response processing unit 14 is configured to respond to an inquiry from the server 20, and reply, for example, an input instruction or a selection result provided by the operator to the server 20.

Each of the components 11 to 14 in the mobile terminal 10 is realized through a cooperative operation of a computer mounted on the mobile terminal 10 and a program operated by the CPU mounted on the computer.

The server 20 includes a captured image receiving unit 21, a work target list creation unit 22, a work procedure manual identifying unit 23, an attachment procedure information providing unit 24, and a work procedure manual storage unit 25. Note that components that are not used to describe the exemplary embodiment are omitted from the drawing.

The captured image receiving unit 21 is configured to receive the captured image transmitted from the mobile terminal 10. The work target list creation unit 22 is configured to analyze the captured image received by the captured image receiving unit 21 to determine the parts 4 being imaged and respective quantities of the parts 4, and create a work target list serving as part information. In the exemplary embodiment, identification information of one of the parts 4 is used to distinguish it from other ones of the parts 4, and a name (hereinafter also referred to as a “part name”) of the one of the parts 4 is used as the identification information.

The work procedure manual storage unit 25 is configured to store electronic data of a detachment work procedure manual (hereinafter also simply referred to as a “work procedure manual”) in which a procedure for detaching the parts 4 from the apparatus 2 is described. By referring to a detachment procedure for parts 4, which is described in a detachment work procedure manual, it is possible to identify the parts 4 that should be detached and respective quantities of the parts 4 to be detached. In a parts list prepared for each detachment work procedure manual, parts 4 that should be detached and respective quantities of the parts 4 are set in an associated manner. Since a work target list is collated with a parts list corresponding to each detachment work procedure manual, as will be described later, the work target list creation unit 22 preferably creates the work target list in an identical data configuration to that of the parts list.

The work procedure manual identifying unit 23 is configured to collate the work target list created by the work target list creation unit 22 with a parts list corresponding to one stored in the work procedure manual storage unit 25 to identify a work procedure manual. That is, the work procedure manual identifying unit 23 is configured to identify a parts list that matches on the basis of the parts 4 detached from the apparatus 2 and the respective quantities of the parts 4, and identify a work procedure manual corresponding to the parts list being identified. Note that a parts list is utilized when included as an additional document or a similar document to a detachment work procedure manual. When no parts list is prepared in advance, the work procedure manual identifying unit 23 may perform text analysis processing on a detachment work procedure manual to create a parts list, for example.

An inquiry processing unit 231 included in the work procedure manual identifying unit 23 is configured to make an inquiry to the operator, for example, when there is not only one work procedure manual describing parts 4 and quantities of the parts 4, which match parts 4 and quantities of the parts 4 included in a work target list, to identify only one work procedure manual.

Incidentally, when it is possible to identify a detachment work procedure manual, it is possible to identify a parts list. However, identifying a parts list does not necessarily mean that it is possible to identify a detachment work procedure manual. One reason of this is that there is a possibility that parts 4 detached from the apparatus 2 in accordance with a certain detachment procedure and quantities of the parts 4 match parts 4 detached in accordance with another detachment procedure and quantities of the parts 4. Note that, in the exemplary embodiment, description will be given based on an assumption that set content in a parts list acquired from a detachment work procedure manual is correct.

The attachment procedure information providing unit 24 is configured to provide, to the operator using the mobile terminal 10 serving as a transmission source of the captured image, attachment procedure information including an attachment procedure for attaching the parts 4 to the apparatus 2 in accordance with the work procedure manual identified by the work procedure manual identifying unit 23.

Each of the components 21 to 24 in the server 20 is realized through a cooperative operation of a computer mounted on the server 20 and a program operated by the CPU mounted on the computer. Furthermore, the work procedure manual storage unit 25 is realized by a hard-disk drive (HDD) mounted on the server 20. Alternatively, the RAM, or an external storage device, if possible, may be utilized via a network.

Although it is to be described that the “information processing system” according to the exemplary embodiment includes a single server computer, as an example, its configuration may include a plurality of computers.

Furthermore, although it is obviously possible to provide the programs used in the exemplary embodiment via a communication medium, it is also possible to provide programs stored in a computer-readable recording medium such as a compact disc read-only memory (CD-ROM) or a Universal Serial Bus (USB) memory. The programs provided from a communication medium or a recording medium are installed in the computer, and the CPU in the computer sequentially executes the programs, thereby realizing various processing.

Next, operation in the exemplary embodiment will be described. Note that, for convenience of explanation, a case where there is only one type of the apparatus 2 serving as a maintenance target will be described herein. That is, it is assumed that a model type has been identified, unless otherwise specified.

In the exemplary embodiment, the operator carries the mobile terminal 10 and moves to the installation location of the apparatus 2 for performing a maintenance work for the apparatus 2. Then, the operator detaches a plurality of types of the parts 4a to 4d from the apparatus 2 in a predetermined order during the maintenance work. The operator appropriately places the parts 4 being detached in a nearby area 6 around the apparatus 2, such as a floor, without being aware of the order of detachment. Incidentally, there are a plurality of types of maintenance works for the apparatus 2, and detachment work procedure manuals are prepared in advance. The detachment work procedure manuals are stored in the work procedure manual storage unit 25, as described above. Therefore, the operator may make a request to the server 20 before performing a maintenance work or during the maintenance work to acquire a detachment work procedure manual corresponding to the maintenance work for the work target, for example, and cause the mobile terminal 10 to display the detachment work procedure manual to perform the maintenance work by referring to the detachment work procedure manual during the maintenance work. Of course, the operator may perform the maintenance work without referring to the detachment work procedure manual. Note that, when the detachment work procedure manual is referred to, chapters, sections, and pages in the detachment work procedure manual, to which references have been made, and an order of the references may be recorded in a log, for example. It is conceivable that the operator performs a detachment work in accordance with a detachment procedure described in a detachment work procedure manual, regardless of whether or not the operator refers to the detachment work procedure manual. Alternatively, it is conceivable that, as a result of detachment of the parts 4, the parts 4 being detached and respective quantities of the parts 4 should necessarily match the parts to be detached and respective quantities of the parts, which are described in at least one detachment work procedure manual. Although, in an actual case, there may be a case where no matching is attained, which case will be described later.

FIG. 1 schematically illustrates an example in which four types of the parts 4, a total quantity of which is five, are detached from the apparatus 2. As the operator detaches the parts 4 that should be detached in the maintenance work from the apparatus 2, the operator captures an image of all the parts 4 being detached. As the image of the parts 4 is captured, the captured image transmission unit 13 transmits the captured image to the server 20.

Note that, although an example is described in the exemplary embodiment for convenience of explanation, in which all the parts 4 being detached are captured in an image and fully accommodated in a frame in one photographing, it is sufficient that the server 20 is able to acquire a captured image of all the parts 4 detached from the apparatus 2, and photographing may be separately performed a plurality of times to capture a plurality of captured images, as long as it is possible to finally acquire images of all the parts 4.

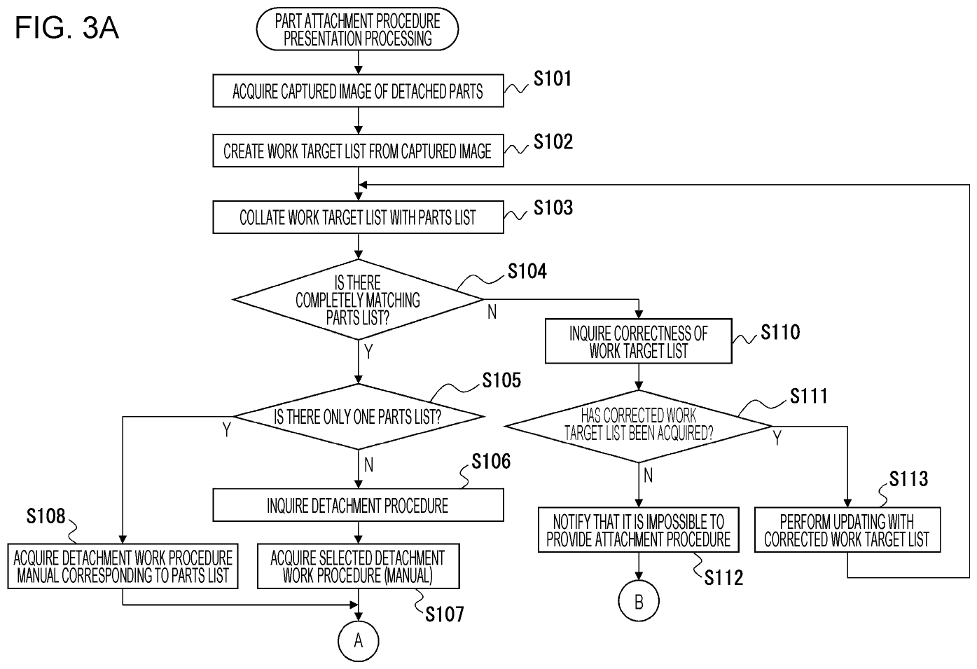

Next, part attachment procedure presentation processing performed in the exemplary embodiment, which starts from when the server 20 acquires a captured image of the parts 4 detached from the apparatus 2 and ends when an attachment procedure for the parts 4 is presented to the operator, will be described with reference to flowcharts illustrated in FIGS. 3A and 3B.

As the captured image receiving unit 21 receives a captured image transmitted from the mobile terminal 10 to acquire the captured image of the parts 4 detached from the apparatus 2 (hereinafter also referred to as “parts being detached” or simply “parts”) (step S101), the work target list creation unit 22 analyzes the captured image being received to extract the parts 4 being detached and photographed, and creates a work target list (step S102).

FIG. 1 illustrates an example of a work target list 8 created from the captured image of all the parts 4. The work target list 8 represents part information regarding the parts 4 being detached and identified through analyzing of the captured image. The work target list 8 is created in such a manner that part names serving as identification information of the parts 4 being detached and quantities of the parts are associated with each other, respectively.

The parts 4 being photographed are recognized in such processing as described below. Note that, although a video may be used, the image is a still image captured by the camera in the exemplary embodiment. Furthermore, although an existing technology may be utilized for the processing itself for recognizing the parts 4 from the captured image, a typical example is described below.

First, it is conceivable that there are a case using a two-dimensional image and a case using a three-dimensional image, as types of images to be discussed. In the case using a two-dimensional image, a plurality of pieces of comparison-purpose image data, in each of which each of the parts included in the apparatus 2 is captured in each of a plurality of directions (for example, from above, from front, and from sides), are prepared in advance. Then, an image of one of the parts 4 being detached, which is extracted from the captured image transmitted from the mobile terminal 10, is compared with each of the plurality of pieces of the comparison-purpose image data of each of the parts to identify a type of the one of the parts 4 being detached.

In the case of a three-dimensional image, three-dimensional shape data is generated and prepared in advance for each of the parts included in the apparatus 2, as comparison-purpose image data. Three-dimensional shape data may be generated from point group data (including each peak of a part or an end point of a side, for example) acquired by utilizing, for example, a depth sensor or a visual simultaneous localization and mapping (Visual SLAM) technique. Three-dimensional shape data is generated by, for example, combining pieces of image data captured from a plurality of positions or in a plurality of postures.

Subsequently, the work procedure manual identifying unit 23 uses the work target list 8 to identify and acquire a detachment work procedure manual from the work procedure manual storage unit 25, and, at that time, collates the work target list 8 with a parts list (step S103). Although a detachment work procedure manual describes a detachment procedure for the parts 4 from the apparatus 2, referring to the detachment procedure makes it possible to identify types of the parts 4 that should be detached and quantities of the parts to be detached. A parts list, in which parts that should be detached and quantities of the parts to be detached are set in an associated manner, is prepared for each detachment work procedure manual. In the exemplary embodiment, the work target list 8 is created to have an identical data configuration to that of a parts list, for ease of comparison.

Although the work procedure manual identifying unit 23 collates the work target list 8 with a parts list corresponding to each detachment work procedure manual, as described above, and when there is a parts list completely matching the work target list 8 (Y in step S104), and when the completely matching parts list is only one (Y in step S105), the work procedure manual identifying unit 23 acquires a detachment work procedure manual corresponding to the parts list (step S108). The term “completely matching” as used herein means that there is matching in both parts configuring a parts list and quantities of the parts.

When there is a parts list completely matching the work target list 8, and when the completely matching parts list is not only one (Y in step S104 and N in step S105), that is, when there are a plurality of such parts lists, the inquiry processing unit 231 in the work procedure manual identifying unit 23 transmits detachment procedures corresponding to the plurality of parts lists, respectively, as selection candidates, to the mobile terminal 10, thereby making an inquiry to the operator about an order in accordance with which the parts 4 have been detached (step S106).

Incidentally, when orders in accordance with which parts have been detached are different from each other due to that maintenance works are different from each other in content, for example, different detachment work procedure manuals are prepared. In other words, as a detachment work procedure manual is identified, a parts list is also identified. On the other hand, when there is matching in parts to be detached and quantities of the parts, parts lists are regarded as identical to each other, even when detachment procedures are different from each other. That is, even when a parts list is identified, it may be impossible to identify one detachment work procedure manual, since there may be a plurality of detachment procedures, parts lists of which completely match each other.

When a list of candidates of detachment procedures is transmitted from the server 20, the inquiry response processing unit 14 in the mobile terminal 10 displays, on the touch panel, and presents, to the operator, the candidates of the detachment procedures in a selectable manner.

It is conceivable that, since the operator has performed a work of detaching the parts 4 until immediately before, the operator is able select the work procedure that the operator has performed from among the detachment procedures being presented. Accordingly, the operator selects the detachment procedure that the operator has performed from among the candidates of the detachment procedures being presented. The inquiry response processing unit 14 replies the detachment procedure selected by the operator.

The inquiry processing unit 231 acquires a detachment work procedure manual corresponding to the detachment procedure replied from the mobile terminal 10, as described above (step S107).

When it is possible to select only one detachment work procedure manual corresponding to the parts list completely matching the work target list 8 from among the detachment work procedure manuals stored in the work procedure manual storage unit 25 (steps S107 and S108), as described above, the attachment procedure information providing unit 24 reverses a detachment procedure described in the detachment work procedure manual, sets an attachment procedure for the parts 4 to the apparatus 2, and transmits and provides attachment procedure information indicating the attachment procedure to the mobile terminal 10 (step S109).

When the attachment procedure is transmitted from the server 20, the attachment procedure presentation unit 122 in the mobile terminal 10 displays, on the touch panel, and presents, to the operator, the attachment procedure being transmitted, for example.

The processing performed in the server 20 described above with reference to FIGS. 3A and 3B will be described again with reference to FIG. 1.

FIG. 1 illustrates two detachment procedures P1 and P2. Although not illustrated, it is understood from the description example that, in a parts list for the detachment procedure P1, quantities of parts A, B, and C are each one, and a quantity of parts D is two. On the other hand, it is understood from the description example that, in a parts list for the detachment procedure P2, quantities of the parts A, B, C, and D are each one. Therefore, it is understood that the work target list 8 created from the captured image by the mobile terminal 10 completely matches the parts list corresponding to the detachment work procedure manual describing the detachment procedure P1. As a result, the server 20 reverses the detachment procedure P1 to create, transmit, to the mobile terminal 10, and present, to the operator, an attachment procedure.

By the way, the work target list 8 created from a captured image is created by analyzing the captured image. Therefore, it is not always possible to accurately extract types and quantities of parts 4 being detached, from the captured image, depending on placement and arrangement of the parts 4. That is, a correct work target list 8 is not always created. Therefore, it may be assumed that the created work target list 8 completely matches no parts list.

Therefore, referring back to FIG. 3A to continue description, when there is no parts list completely matching the work target list 8 (N in step S104), the inquiry processing unit 231 transmits the work target list 8 to the mobile terminal 10 to make an inquiry to the operator for correctness of the work target list 8 (step S110).

As the work target list 8 is transmitted from the server 20, the inquiry response processing unit 14 in the mobile terminal 10 displays, on the touch panel, and presents, to the operator, the work target list 8 in a correctable manner.

Since the operator has placed the parts 4 in the nearby area 6 around the apparatus 2, the operator is able to know correct types of the parts 4 being detached and correct quantities of the parts 4 being detached. Therefore, the operator refers to the work target list 8 displayed on the touch panel, and, if there is an error in the work target list 8, corrects the error. When the work target list 8 is corrected by the operator, the inquiry response processing unit 14 replies the work target list 8 updated based on the correction. On the other hand, when the operator has not made a correction on the work target list 8 being presented, it is regarded that there is no error in the work target list 8. In this case, the inquiry response processing unit 14 replies a fact that the work target list 8 has not been corrected by the operator, in other words, the work target list 8 is correct.

The inquiry processing unit 231 receives a reply from the mobile terminal 10. Note herein that, as the work target list 8 being corrected has been transmitted (Y in step S111), the work target list 8 created from the captured image is updated with the work target list 8 being corrected (step S113). Then, the processing returns to step S103, and executes those described above.

When a reply indicating that the work target list 8 has not been corrected by the operator and is correct is received from the mobile terminal 10, on the other hand, a fact that, although the work target list 8 is correct, there is no parts list completely matching the work target list 8 means that there is no detachment work procedure manual serving as a source for creating an attachment procedure. Therefore, since it is impossible to create an attachment procedure, the attachment procedure information providing unit 24 transmits a message indicating so, that is, a message indicating that it is impossible to provide an attachment procedure, to the mobile terminal 10 to notify the operator of that effect (step S112).

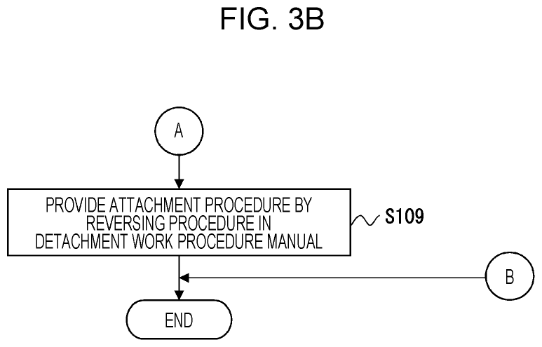

The processing described above with reference to FIGS. 3A and 3B when there is no parts list completely matching the work target list 8 will be described again with reference to FIGS. 4A to 4D.

FIG. 4A illustrates an example of a captured image of parts 4, FIG. 4B illustrates a work target list 8 acquired from the captured image, and FIG. 4C illustrates the work target list 8 after corrected by the operator. FIG. 4D illustrates, for reference purposes, part name information indicating relationships between images of the parts 4 appeared in FIG. 4A and part names.

In step S102, when there is no parts list completely matching the work target list 8 created by analyzing the captured image, the work target list 8 is transmitted to the mobile terminal 10 to make an inquiry to the operator. Then, when there is an error in the work target list 8 (FIG. 4B) presented to the operator, the operator corrects the error. By comparing the parts 4 actually placed on the floor, for example, with those in the work target list 8 (FIG. 4B) displayed on the touch panel of the mobile terminal 10, the operator is able to easily check correctness of the work target list 8.

When the work target lists 8 illustrated in FIG. 4B and FIG. 4C are compared with each other, it is understood that the operator has corrected a part F to the part B, has corrected the quantities of the part A and the part C, and has made a correction of deleting a part E because the part E is an error of the part C. Note that, in the work target list 8 illustrated in FIG. 4C, locations of the corrections are underlined for convenience purposes.

In this way, when there are errors in the work target list 8 (FIG. 4B) automatically acquired through analyzing of the captured image, it is possible to prompt the operator to correct the errors. Then, it is conceivable that using the work target list 8 after correction (FIG. 4C) to newly perform collation with parts lists makes it possible to find a completely matching parts list (step S103).

However, the operator is not able to always make a correction in content of the work target list 8. It is also possible to assume such a case where no part names have been correctly known or a case where a part is confused with a similar part, for example. That is, it is conceivable that it is impossible to acquire an accurate work target list 8 as a result, and it is impossible to find a completely matching parts list as a result.

In this case, in the case where there has been no completely matching parts list even when the operator has made a correction on the work target list 8, and it has been impossible to identify a detachment work procedure manual as a result of a fact that the operator has made no correction on the work target list 8 (N in step S104 and N in step S111) in the above description, the operator has been notified that it is impossible to provide an attachment procedure (step S112) in the above description. However, before a notification is provided, the work procedure manual identifying unit 23 may refer to the work procedure manual storage unit 25, search for parts lists similar to a latest work target list 8, and select and present, to the operator, one or more of the parts lists, which is or are extracted as a result of the search as one candidate or a plurality of candidates of correct work target lists 8. Note that, instead of a parts list, or together with a parts list, a detachment procedure described in a detachment work procedure manual corresponding to the parts list may be presented. In this way, the operator may be notified that there is a possibility of an error in a work target list 8 that the operator has once recognized as correct, and the operator may be presented with one or a plurality of parts lists serving as candidates for correcting the work target list 8.

As the operator selects one parts list from among the candidates of the parts lists, the work procedure manual identifying unit 23 regards the selected parts list as a work target list 8 after correction (Y in step S111), allowing the processing to return to step S103. In this case, it is conceivable that there is always a completely matching parts list.

Note that, to determine similarity between the work target list 8 and a parts list, a determination criterion for similarity may be set in advance for those cases, such as when configurations of types of parts are identical to each other but quantities of some of the parts differ from each other by one or more, or types of some of the parts differ from each other by one or more, and a parts list similar to the work target list 8 may be extracted in accordance with the determination criterion.

In the exemplary embodiment, it has been made possible to present, to the operator, an attachment procedure for re-attaching parts 4 being detached, as described above. At this time, although it is necessary to identify only one parts list completely matching the work target list 8, information that serves as a reference for processing of identifying the one parts list may be acquired from the operator.

For example, an image of tools and jigs used to detach parts 4 is captured together with the parts 4. Alternatively, if a part 4 is scheduled to be replaced with a new one, an image of the part 4 to be replaced with a new one is also captured. Note that, although the exemplary embodiment has been described by assuming that the parts 4 detached from the apparatus 2 are re-attached, there may be such a case where the parts 4 being detached are to be replaced with new ones. In this case, it is necessary to appropriately read a “part to be detached”, which is to be replaced with a new one, as a “part to be replaced with a new one”. When a part 4 being detached is replaced with a new one, it is necessary to make improvements in photographing and arranging the part 4 to provide a clear correspondence relationship between the part 4 before replaced with a new one and that after replaced with the new one, and to prevent an error in calculation of a quantity of the part from occurring. For example, a rule may be provided for arranging a part 4, or text information such as a provided comment may be added to or included in a captured image. Accordingly, even when it is impossible to identify only one parts list through a mere comparison between a work target list 8 and a parts list, referring to additional information such as a captured image of a tool, for example, as described above, makes it easier to identify only one parts list. That is, it is possible to utilize information regarding a jig or a replacement part as support-purpose information for processing of narrowing down parts lists and identifying one parts list. Under an instruction provided from the operator, the mobile terminal 10 may not include, in a captured image of a part 4, but may separately transmit, to the server 20, such support-purpose information.

Note that the above description has been provided by limiting that there is one model type of the apparatus 2 that is a maintenance target. When there are a plurality of model types of apparatuses 2, information (for example, a model type code) identifying the model type of each of the apparatuses 2 may be added to a captured image to be transmitted from the mobile terminal 10 to the server 20, or a captured image of each of the apparatuses 2 may further be transmitted, to make it possible to identify each of the apparatuses 2, and to make it possible to narrow down a detachment work procedure manual corresponding to each of the model types, from among the detachment work procedure manuals stored in the work procedure manual storage unit 25.

By the way, attachment procedure information to be presented to the operator includes an attachment procedure for parts 4, as illustrated in FIG. 1. However, a form of attachment procedure information to be presented to the operator is not limited to this example. Basically, text information may be presented, as illustrated in FIG. 1, and a still image may be presented when text information is presented. However, attachment procedure information may be presented by utilizing a video or, when the mobile terminal 10 has a display function utilizing an augmented reality (AR) technique (hereinafter referred to as an “AR function”), by utilizing the AR function.

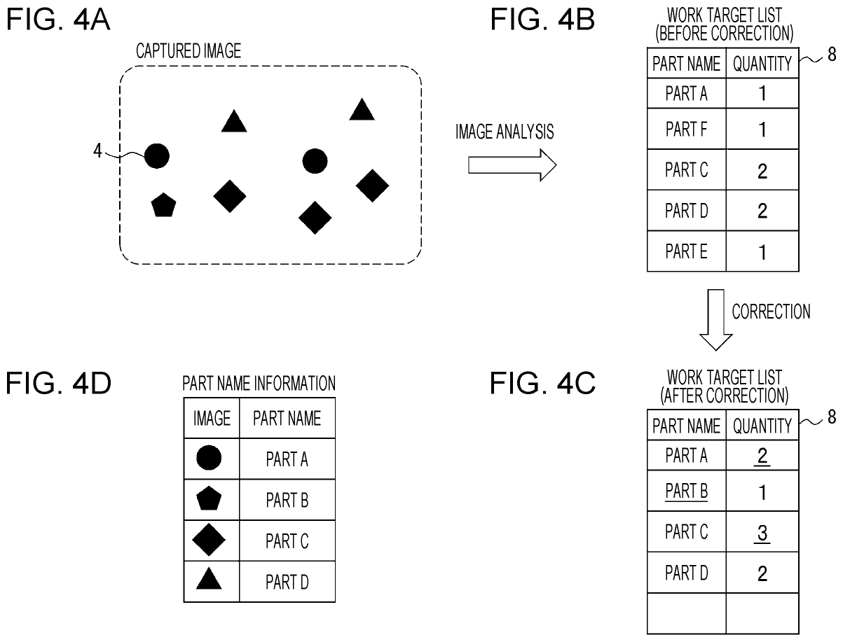

Hereinafter, a display example of attachment procedure information will be described with reference to the drawings. Although the attachment procedure information for the parts 4 has been displayed in a form of text information in FIG. 1, image information may be schematically displayed, as illustrated in FIGS. 5 to 7.

Note that the processor in the mobile terminal 10 cooperates with the processor in the server 20, and performs display control on the touch panel in accordance with the attachment procedure information and a display control instruction for the information, which are transmitted from the server 20. More specifically, the server 20 transmits the attachment procedure information to the mobile terminal 10 and controls the mobile terminal 10 to display the attachment procedure information, and the mobile terminal 10 displays the attachment procedure information in accordance with the control by the server 20.

When the processor in the mobile terminal 10 and the processor in the server 20 perform displaying of the attachment procedure information in cooperation with each other, as described above, it may be conceivable that the information processing system includes not only the server 20 but also the mobile terminal 10. Note herein that, however, there may be a case where, for convenience of explanation, control processing performed in the server 20 may be omitted, and such processing that the mobile terminal 10 displays attachment procedure information may be described.

FIG. 5 is a diagram illustrating a screen display example of attachment procedure information displayed on the touch panel of the mobile terminal 10. As illustrated in FIG. 5, the attachment procedure presentation unit 122 causes images of parts 4 to be attached to an apparatus 2 to be displayed together with attachment-order numbers, in accordance with which the parts 4 are attached to the apparatus 2, respectively, in an associated manner. In the display example illustrated in FIG. 5, the attachment-order numbers are indicated by circled numbers 31 disposed near the parts 4, respectively. Of course, the display form of the attachment-order numbers is a mere example, and such attachment-order numbers to be displayed may not be in the form of the circled numbers 31 but may take another form, as long as the numbers indicating the order are distinguishable.

When the mobile terminal 10 utilizes the AR function to display attachment procedure information, the mobile terminal 10 uses the camera to capture an image of the parts 4 being detached and placed in the nearby area 6 around the apparatus 2. In the photographing referred herein, it is not always necessary to generate data of a captured image. As an order of attaching each of the parts 4 is identified in photographing from the attachment procedure information received from the server 20, the attachment procedure presentation unit 122 causes an attachment procedure, together with the circled numbers 31 associated with the parts 4, respectively, to be displayed, as illustrated in FIG. 5.

When the mobile terminal 10 is equipped with no AR function, or when no AR function is utilized, on the other hand, the attachment procedure information providing unit 24 adds, to images of the parts 4 included in the captured image acquired by the imaging unit 11, attachment-order numbers of the parts 4 to the apparatus 2 in accordance with the attachment procedure, respectively. Then, the attachment procedure information providing unit 24 transmits the captured image after the attachment-order numbers are added to the images of the parts 4, respectively, to the mobile terminal 10, as attachment procedure information. Accordingly, the attachment procedure presentation unit 122 in the mobile terminal 10 is able to display the captured image transmitted from the server 20 to present the attachment procedure information illustrated in FIG. 5 to the operator.

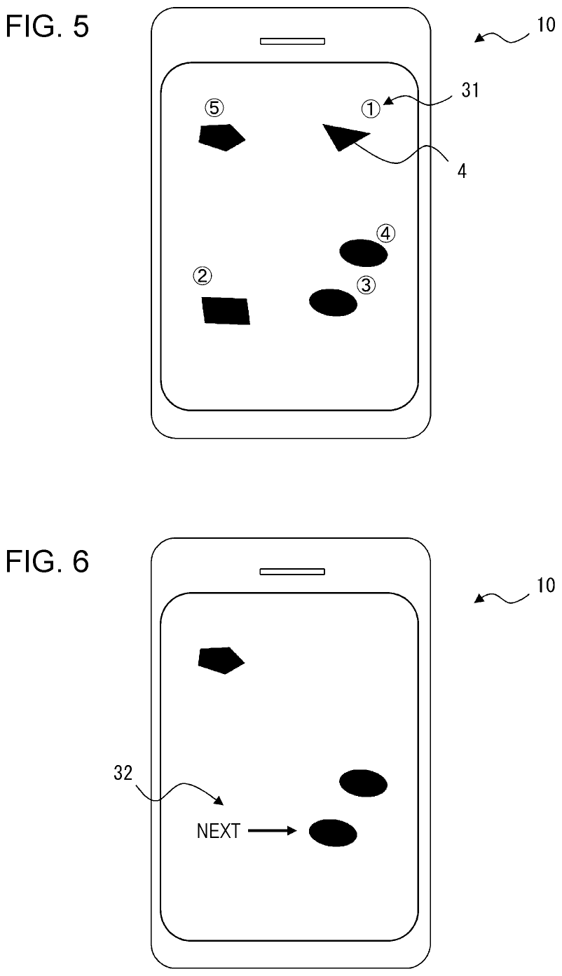

FIG. 6 is a diagram illustrating another example of screen display of attachment procedure information displayed on the touch panel of the mobile terminal 10. Although FIG. 5 is the display example of a state where none of the parts 4 have been attached to the apparatus 2, FIG. 6 is the display example of a state where some of the parts 4 (the parts B and C in FIG. 6), which had been detached, have already been attached to the apparatus 2. Then, the attachment procedure presentation unit 122 causes one of the parts 4, which should be next attached, to be displayed in an identifiable manner. In the screen display example illustrated in FIG. 6, a display element 32 combining text information “Next” and an arrow with each other presents one of the parts 4, which is to be next attached, to the operator.

When the mobile terminal 10 is equipped with the AR function, the mobile terminal 10 uses the camera to capture an image of the nearby area 6 around the apparatus 2, similar to the case described with reference to FIG. 5. Note herein that, however, since some of the parts 4 (the parts B and C in FIG. 6), which had been detached, have already been attached, the attachment procedure presentation unit 122 collates the attachment procedure for the parts 4, which is provided in the attachment procedure information, with others of the parts 4, which have not yet been attached, in the captured image, identifies one of the parts 4, which is to be next attached, uses the display element 32, and causes the one of the parts 4, which is to be next attached, to be displayed in an identifiable manner.

The display form of the attachment procedure information illustrated in FIG. 6 is basically realized by utilizing the AR function. Even when the mobile terminal 10 is equipped with or utilizes no AR function, however, it is possible to cause the attachment procedure information illustrated in FIG. 6 to be displayed.

For example, the attachment procedure information providing unit 24 transmits a captured image to the mobile terminal 10, similar to the case described with reference to FIG. 5. However, no attachment procedure corresponding to the circled numbers 31 is presented, but a display element 32 is associated with one of the parts 4, which is to be first attached. The attachment procedure presentation unit 122 in the mobile terminal 10 causes the captured image transmitted from the server 20 to be displayed. As the operator attaches the one of the parts 4, which is instructed with the display element 32 being displayed, to the apparatus 2, the operator performs a predetermined operation indicating that the part has been attached. The mobile terminal 10 transmits an information transmission request including information that the one of the parts 4 has been attached to the server 20, in response to the predetermined operation performed by the operator. In response to the information transmission request transmitted from the mobile terminal 10, the attachment procedure information providing unit 24 deletes the one of the parts 4, which has been attached, from the captured image, associates the display element 32 with an image of another one of the parts 4, which should be next attached, and transmits the captured image to the mobile terminal 10. The mobile terminal 10 and the server 20 cooperatively repeat the processing using an information transmission request, as described above, making it possible to realize the screen display illustrated in FIG. 6, even when the mobile terminal 10 utilizes no AR function. In the processing using an information transmission request, as described above, the attachment procedure information providing unit 24 is able to divide the attachment procedure information into pieces, and transmit the pieces of the attachment procedure information.

Regardless of whether or not the mobile terminal 10 utilizes the AR function, it is possible to cause one of the parts 4, which is to be next attached to the apparatus 2, to be displayed in an identifiable manner, from among the parts 4 detached from the apparatus 2, as described above.

Note that, although the display element 32 including the text “Next” and the arrow is displayed to allow one of the parts 4, which is to be next attached, to be identified, in FIG. 6, it is not necessary to limit the display element 32 to have this form. For example, one of the parts 4, which is to be next attached, may be indicated in a circle.

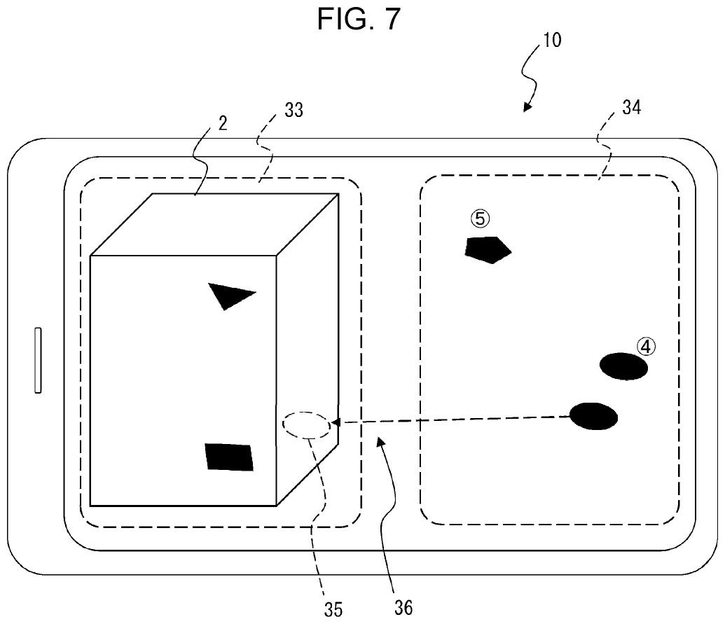

FIG. 7 is a diagram illustrating still another example of screen display of attachment procedure information displayed on the touch panel of the mobile terminal 10. The screen display example illustrated in FIG. 6 has illustrated display content for presenting one of the parts 4, which is to be next attached, to the operator, from among the parts 4 to be attached to the apparatus 2. In the screen display example illustrated in FIG. 7, not only one of the parts 4, which is to be next attached to the apparatus 2, is presented to the operator, from among the parts 4 detached from the apparatus 2, but also an attachment position of the one of the parts 4, which is to be next attached to the apparatus 2, is further displayed. It is possible to relatively easily form the screen display example illustrated in FIG. 7 by utilizing the AR function.

FIG. 7 illustrates the screen display example in which a left half of the touch panel of the mobile terminal 10 serves as a display region 33 for the apparatus 2, and a right half serves as a display region 34 for the parts 4 being detached. Of course, ranges and layouts of the display regions 33 and 34 are mere examples, and the present disclosure is not limited to the screen display example illustrated in FIG. 7.

In order to perform the screen display illustrated in FIG. 7, the mobile terminal 10 needs to acquire an image of the apparatus 2 and to know attachment positions of the parts 4 being detached, with respect to the apparatus 2. As to an image of the apparatus 2, it is sufficient that an image of the apparatus 2 is captured using the camera and displayed in the display region 33. The attachment positions of the parts 4 being detached are identical to the detachment positions of the parts 4. Incidentally, since it is possible to identify the detachment positions of the parts 4 as a detachment work procedure manual is identified, it is sufficient that the mobile terminal 10 acquires attachment procedure information including a detachment work procedure manual from the server 20. Alternatively, it is sufficient that the server 20 identifies attachment positions of the parts 4, which are identifiable from a detachment work procedure manual, and the mobile terminal 10 acquires attachment procedure information including the identified attachment positions of the parts 4 from the server 20.

The attachment procedure presentation unit 122 in the mobile terminal 10 adds one of the parts 4, which has been attached, to the image of the apparatus 2 for display. In displaying utilizing the AR function, even if it is impossible to visually recognize a part 4, which is attached inside the apparatus 2, it is possible to identify an attachment position of the part 4 from a detachment work procedure manual, making it possible to virtually display the part. Regarding displaying of the display region 34 for the parts 4 being detached, it is sufficient that the processing using those described with reference to FIG. 6 is performed. In the screen display example illustrated in FIG. 7, an attachment position 35 for one of the parts 4, which is to be next attached to the apparatus 2, is indicated by an arrow 36, instead of the display element 32 indicating one of the parts 4, which is to be next attached, which is illustrated in FIG. 6. As illustrated in FIG. 7, plotting the attachment position 35 for the one of the parts 4 in a shape of one of the parts 4, which is to be attached, makes it possible to easily draw imagination. Furthermore, the attachment position 35 is indicated by a broken line for easy discrimination from other ones of the part 4, which have already been attached.

Although utilizing the AR function makes it possible to relatively easily form the screen display example illustrated in FIG. 7, it is also possible to form the screen display illustrated in FIG. 7, even when no AR function is utilized, by transmitting and providing an image of the apparatus 2, which is prepared in advance, to the mobile terminal 10, since the server 20 is able to identify the model type of the apparatus 2 from a detachment work procedure manual.

In the exemplary embodiment described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the processor in the exemplary embodiment described above may be not only operations performed by one processor, but also operation performed, in cooperation with each other, by a plurality of processors that exist at physically distant positions. Furthermore, the order of the operations of the processor is not limited to the order described in the exemplary embodiment described above, and may be appropriately modified.

### APPENDIX

(((1)))

An information processing system comprising a processor, wherein the processor is configured to
acquire a captured image of parts detached from an apparatus,
use the captured image to select, from among pieces of detachment information stored in a storage unit, the pieces of detachment information each indicating a detachment procedure for parts from the apparatus, one of the pieces of detachment information corresponding to the parts detached from the apparatus, and
present attachment procedure information indicating an attachment procedure to the apparatus, the attachment procedure being set by reversing the detachment procedure for the parts, the detachment procedure being indicated by the one of the pieces of detachment information being selected.
   (((2)))

The information processing system according to (((1))), wherein the processor is further configured to
create part information including identification information of the parts being photographed and quantities of the parts, the parts and the quantities of the parts being identified by analyzing the captured image, and
select, from among the pieces of detachment information stored in the storage unit, one of the pieces of detachment information, in which identification information of parts that are detachment targets and quantities of the parts, the parts and the quantities of the parts being identified from the one of the pieces of detachment information, match the identification information of the parts and the quantities of the parts, the parts and the quantities of the parts being included in the part information, as the one of the pieces of detachment information corresponding to the parts detached from the apparatus.
   (((3)))

The information processing system according to (((2))), wherein the processor is further configured to
present the part information to a user in a correctable manner, and
update, when the part information being presented is corrected by the user, the part information with content of the correction.
   (((4))

The information processing system according to (((2))) or (((3))), wherein the processor is further configured to,
when there is no detachment information matching the identification information of the parts and the quantities of the parts, the parts and the quantities of the parts being included in the part information, among the pieces of detachment information stored in the storage unit,
select, from among the pieces of detachment information stored in the storage unit, one of the pieces of detachment information, in which identification information of parts that are detachment targets and quantities of the parts, the parts and the quantities of the parts being identified from the one of the pieces of detachment information, are similar to the identification information of the parts and the quantities of the parts, the parts and the quantities of the parts being included in the part information, as a candidate of detachment information corresponding to the parts detached from the apparatus, and
present the candidate of detachment information being selected to the user to urge the user to select one of the pieces of detachment information corresponding to the parts detached from the apparatus.
   (((5)))

The information processing system according to (((2))) or (((3))), wherein the processor is further configured to,
when a plurality of pieces of detachment information matching the identification information of the parts and the quantities of the parts, the parts and the quantities of the parts being included in the part information, exist in the pieces of detachment information stored in the storage unit,
present the plurality of pieces of detachment information that exist to the user as selection candidates, and
urge the user to select one of the pieces of detachment information corresponding to the parts detached from the apparatus.
   (((6)))

The information processing system according to any one of (((1))) to (((5))), wherein the processor is further configured to cause images of the parts detached from the apparatus to be displayed together with attachment-order numbers, in accordance with which the parts are to be attached to the apparatus, in an associated manner, respectively, as the attachment procedure information.

(((7)))

The information processing system according to (((6))), wherein the processor is further configured to, when a terminal device displays the parts detached from the apparatus, cause the terminal device to display the parts displayed by the terminal device together with attachment-order numbers, in accordance with which the parts are to be attached to the apparatus, in an associated manner, respectively, as the attachment procedure information.

(((8)))

The information processing system according to (((6))), wherein the processor is further configured to
add, to the images of the parts included in the captured image being acquired, attachment-order numbers, in accordance with which the parts are to be attached to the apparatus, respectively, and
present the captured image after the attachment-order numbers have been added to the images of the parts, respectively, as the attachment procedure information.
   (((9)))

The information processing system according to any one of (((1))) to (((5))), wherein the processor is further configured to cause one of the parts, the one of the parts being to be next attached to the apparatus, to be displayed in an identifiable manner, among the parts detached from the apparatus, as the attachment procedure information.

(((10)))

The information processing system according to any one of (((1))) to (((5))), wherein the processor is further configured to cause one of the parts, the one of the parts being to be next attached to the apparatus, among the parts detached from the apparatus, and an attachment position for the one of the parts to the apparatus, to be displayed, as the attachment procedure information.

(((11))

A non-transitory computer readable medium storing a program causing a computer to execute a process for realizing functions, the functions comprising:
a function of acquiring a captured image of parts detached from an apparatus;
a function of using the captured image to select, from among pieces of detachment information stored in a storage unit, the pieces of detachment information each indicating a detachment procedure for parts from the apparatus, one of the pieces of detachment information corresponding to the parts detached from the apparatus; and
a function of presenting attachment procedure information indicating an attachment procedure to the apparatus, the attachment procedure being set by reversing the detachment procedure for the parts, the detachment procedure being indicated by the one of the pieces of detachment information being selected.

What is claimed is:

1. An information processing system comprising a processor, wherein the processor is configured to
acquire a captured image of parts detached from an apparatus,
use the captured image to select, from among pieces of detachment information stored in a storage unit, the pieces of detachment information each indicating a detachment procedure for parts from the apparatus, one of the pieces of detachment information corresponding to the parts detached from the apparatus, and
present attachment procedure information indicating an attachment procedure to the apparatus, the attachment procedure being set by reversing the detachment procedure for the parts, the detachment procedure being indicated by the one of the pieces of detachment information being selected.

2. The information processing system according to claim 1, wherein the processor is further configured to
create part information including identification information of the parts being photographed and quantities of the parts, the parts and the quantities of the parts being identified by analyzing the captured image, and
select, from among the pieces of detachment information stored in the storage unit, one of the pieces of detachment information, in which identification information of parts that are detachment targets and quantities of the parts, the parts and the quantities of the parts being identified from the one of the pieces of detachment information, match the identification information of the parts and the quantities of the parts, the parts and the quantities of the parts being included in the part information, as the one of the pieces of detachment information corresponding to the parts detached from the apparatus.

3. The information processing system according to claim 2, wherein the processor is further configured to
present the part information to a user in a correctable manner, and
update, when the part information being presented is corrected by the user, the part information with content of the correction.

4. The information processing system according to claim 2, wherein the processor is further configured to,
when there is no detachment information matching the identification information of the parts and the quantities of the parts, the parts and the quantities of the parts being included in the part information, among the pieces of detachment information stored in the storage unit,
select, from among the pieces of detachment information stored in the storage unit, one of the pieces of detachment information, in which identification information of parts that are detachment targets and quantities of the parts, the parts and the quantities of the parts being identified from the one of the pieces of detachment information, are similar to the identification information of the parts and the quantities of the parts, the parts and the quantities of the parts being included in the part information, as a candidate of detachment information corresponding to the parts detached from the apparatus, and
present the candidate of detachment information being selected to the user to urge the user to select one of the pieces of detachment information corresponding to the parts detached from the apparatus.

5. The information processing system according to claim 2, wherein the processor is further configured to,
when a plurality of pieces of detachment information matching the identification information of the parts and the quantity of the parts, the parts and the quantity of the parts being included in the part information, exist in the pieces of detachment information stored in the storage unit,
present the plurality of pieces of detachment information that exist to the user as selection candidates, and
urge the user to select one of the pieces of detachment information corresponding to the parts detached from the apparatus.

6. The information processing system according to claim 1, wherein the processor is further configured to cause images of the parts detached from the apparatus to be displayed together with attachment-order numbers, in accordance with which the parts are to be attached to the apparatus, in an associated manner, respectively, as the attachment procedure information.

7. The information processing system according to claim 6, wherein the processor is further configured to, when a terminal device displays the parts detached from the apparatus, cause the terminal device to display the parts displayed by the terminal device together with attachment-order numbers, in accordance with which the parts are to be attached to the apparatus, in an associated manner, respectively, as the attachment procedure information.

8. The information processing system according to claim 6, wherein the processor is further configured to
add, to the images of the parts included in the captured image being acquired, attachment-order numbers, in accordance with which the parts are to be attached to the apparatus, respectively, and
present the captured image after the attachment-order numbers have been added to the images of the parts, respectively, as the attachment procedure information.

9. The information processing system according to claim 1, wherein the processor is further configured to cause one of the parts, the one of the parts being to be next attached to the apparatus, to be displayed in an identifiable manner, among the parts detached from the apparatus, as the attachment procedure information.

10. The information processing system according to claim 1, wherein the processor is further configured to cause one of the parts, the one of the parts being to be next attached to the apparatus, among the parts detached from the apparatus, and an attachment position for the one of the parts to the apparatus, to be displayed, as the attachment procedure information.

11. A non-transitory computer readable medium storing a program causing a computer to execute a process for realizing functions, the functions comprising:
a function of acquiring a captured image of parts detached from an apparatus;
a function of using the captured image to select, from among pieces of detachment information stored in a storage unit, the pieces of detachment information each indicating a detachment procedure for parts from the apparatus, one of the pieces of detachment information corresponding to the parts detached from the apparatus; and
a function of presenting attachment procedure information indicating an attachment procedure to the apparatus, the attachment procedure being set by reversing the detachment procedure for the parts, the detachment procedure being indicated by the one of the pieces of detachment information being selected.
